(19) United States
(12) Patent Application Publication
(10) Pub. No.: US 2015/0066695 A1
(43) Pub. Date: Mar. 5, 2015

(54) CROSS BORDER TRADE ENTITY VISIBILITY COMPLIANCE SYSTEM

(71) Applicant: eBay Inc., San Jose, CA (US)

(72) Inventors: Marc Delingat, Mountain View, CA (US); James Shen, San Jose, CA (US); Joseph Edward Black, Mountain View, CA (US); Shamla Soans, Fremont, CA (US); Yoram Vardi, Sunnyvale, CA (US)

(21) Appl. No.: 14/139,820

(22) Filed: Dec. 23, 2013

Related U.S. Application Data
(60) Provisional application No. 61/873,293, filed on Sep. 3, 2013.

(51) Int. Cl. G06Q 30/06

(52) U.S. Cl. CPC G06Q 30/0609
USPC 705/26.35

(57) ABSTRACT

Techniques for controlling visibility settings of data entities (for example but not limited to item listings, items, products and services, stock keeping units (SKUs) reviews, collections, lists, adverts, etc.) on a networked commerce system are described. According to various embodiments, a seller specification of an item is received, via a user interface, in connection with a request to post item information on a networked commerce system. Entity visibility compliance rules regarding the online sale of items in one or more regions are then accessed. Thereafter, the item specified by the seller is determined to be subject to a particular entity visibility compliance rule in a particular region. An entity visibility setting may then be adjusted for that item information throughout the networked commerce system in that particular region, based on the particular entity visibility compliance rule.

### CLAIM OF PRIORITY

This application claims the priority benefit of U.S. Provisional Application No. 61/873,293, filed Sep. 3, 2013, which is incorporated herein by reference.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2013, All Rights Reserved.

### TECHNICAL FIELD

The present application relates generally to data processing systems and, in one specific example, to techniques for controlling visibility settings of data entities for example but not limited to item listings, items, products and services, stock keeping units (SKUs) reviews, collections, lists, adverts, etc.) on a networked commerce system in the context of cross-border trade.

### BACKGROUND

As online retailers and marketplaces such as eBay® become more popular in various regions around the world, there are an increasing number of cross-border trade transactions being conducted online via such websites. For example, on the eBay® marketplace website, an increasing number of product items and services are listed for sale by sellers in a given “region” are being purchased by (and ultimately delivered to) buyers in other “regions”.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed;

FIG. 2 is a block diagram of an example system, according to various embodiments;

FIG. 3 illustrates an example of entity visibility compliance rules, according to various embodiments;

FIG. 4 is a flowchart illustrating an example method, according to various embodiments;

FIG. 5 illustrates an exemplary portion of a user interface, according to various embodiments;

FIG. 6 illustrates an exemplary portion of item information, according to various embodiments;

FIG. 7 illustrates an exemplary portion of a user interface, according to various embodiments;

FIG. 8 is a flowchart illustrating an example method, according to various embodiments;

FIG. 9 is a flowchart illustrating an example method, according to various embodiments;

FIG. 10 is a flowchart illustrating an example method, according to various embodiments;

FIG. 11 illustrates an exemplary mobile device, according to various embodiments; and

FIG. 12 is a diagrammatic representation of a machine in the example form of a computer system within which a set of instructions, for causing the machine to perform any one or more of the methodologies discussed herein, may be executed.

### DETAILED DESCRIPTION

Example methods and systems for controlling visibility settings of data entities on a networked commerce system in the context of cross-border trade are described. In the following description, for purposes of explanation, numerous specific details are set forth in order to provide a thorough understanding of example embodiments. It will be evident, however, to one skilled in the art that the present invention may be practiced without these specific details.

According to various exemplary embodiments, an entity visibility compliance system is configured to control, on a granular level, whether it is acceptable for sellers on a networked commerce system (e.g., a retailer website or online marketplace such as eBay®) to display, market, offer to sell, or a sell various items in various regions. For example, different regions around the world tend to have different laws and rules regarding what type of products and services may be offered for sale online, what type of products and services can be marketed online to users, what type of products and services can be viewed by users, what type of products and services can be included in search results, and so on. As one example, the sale of German military insignia from the Second World War is forbidden in Germany but allowed in the United States.

Accordingly, as cross-border trade becomes a more important element in the success of multinational companies such as online retailers, marketplace website, and other networked commerce systems, the entity visibility compliance system 200 described herein may be applied to help navigate the complexities of different laws and compliance rules pertaining to the online display and sale of items (e.g., products and/or services) in different regions around the world. For example, in some embodiments, the entity visibility compliance system 200 may access rules indicating that specific products and services may not be sold, displayed, or marketed in a given region. Accordingly, the entity visibility compliance system 200 may adjust the visibility of data entities, search results, marketing associated with products and services, and so on, to various users in various regions, based on such rules.

While various embodiments herein refer to the selling of items across borders, the embodiments herein are applicable to various types of entities, where an item is only one non-limiting example of an entity. Using eBay's recently released “collections” feature as an example, various embodiments described herein control not only whether an “item” would be visible to a user but also to control the visibility of the “collection”, where the “collection” is a different entity than the item. Other entities that this invention may control may be lists, merchandizing placements, user comments, reviews, product catalogues, product catalogue entries (products), images for products, sellers, stores, feedback comments, shipping methods, and so on. Accordingly, the embodiments described herein are applicable to any entities related to commercial transactions of items which represent goods or services between regions of different rules/regulations.

It is understood that the entity visibility compliance system described herein does not only apply to a system that is basis for a website. Instead, the entity visibility compliance system may be integrated as part of a backend of a commerce infrastructure and as such may operate on entities and information that may show up on websites but may also just be entered and accessed through APIs or other technical interfaces that may or may not be website based.

As described herein, a “networked commerce system” refers to any online or offline system that facilities commercial transactions through a network (e.g., the Internet). Examples of networked commerce systems include websites (e.g., retailer websites, marketplace websites and e-commerce websites, such as eBay® and Amazon®), shops, physical stores, online digital stores, kiosks, interactive billboards, digital storefronts, shoppable windows, mobile apps (e.g., for installation on a mobile device), and so on. Accordingly, the embodiments described herein are not limited in application to visibility control on marketplaces, and may be applied to any online or offline system facilitating commercial transactions through a network.

As described herein, a “region” may correspond to, for example, a country, a nation state, a state, a county, a local government area, a sovereignty, a legal jurisdiction, an administrative region, a geographic region, a cultural region, or any other region subject to specific regulations, practice, or laws related to commercial transactions for goods and services. As described herein, “cross border trade” refers not only to trade across borders between nation states, but also to trade across any kind of border between geographic regions subject to differences in regulations, practice, or laws related to commercial transactions for goods and services (such as different US states, counties, but also between different trade areas such as the EU and the South American customs union, etc.).

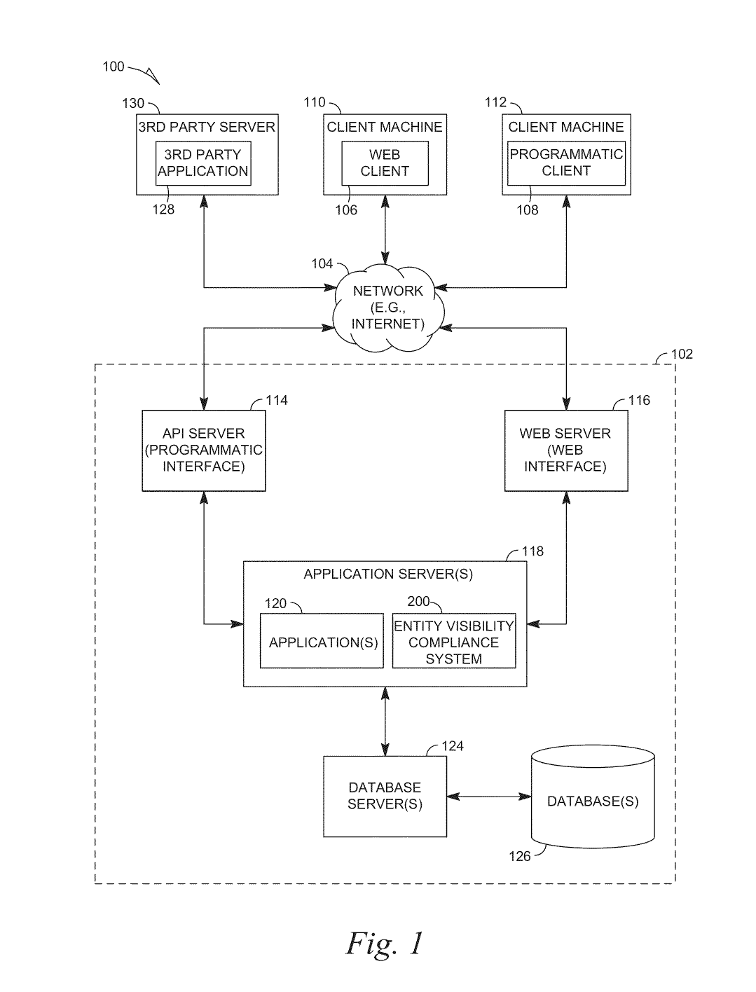

FIG. 1 is a network diagram depicting a client-server system 100, within which one example embodiment may be deployed. A networked system 102 provides server-side functionality via a network 104 (e.g., the Internet or Wide Area Network (WAN)) to one or more clients. FIG. 1 illustrates, for example, a web client 105 (e.g., a browser), and a programmatic client 108 executing on respective client machines 110 and 112.

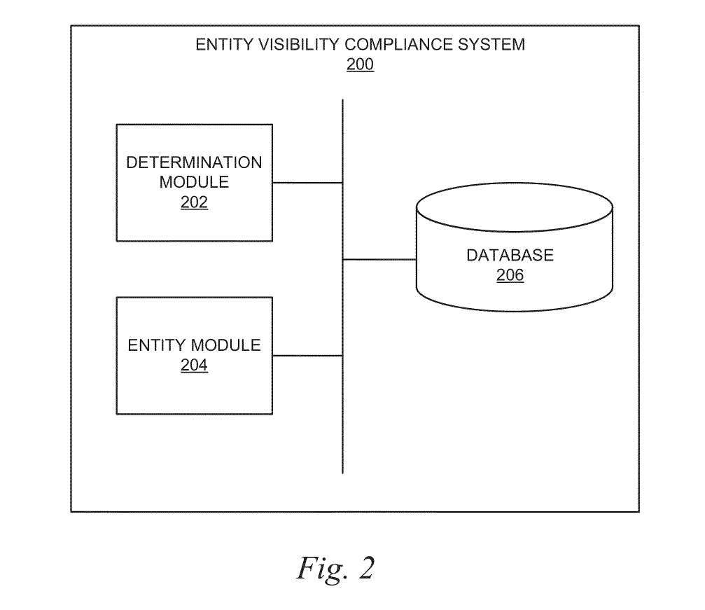

An Application Program interface (API) server 114 and a web server 116 are coupled to, and provide programmatic and web interfaces respectively to, one or more application servers 118. The application servers 118 host one or more applications 120. The application servers 118 are, in turn, shown to be coupled to one or more databases servers 124 that facilitate access to one or more databases 126. According to various exemplary embodiments, the applications 120 may be implemented on or executed by one or more of the modules of the entity visibility compliance system 200 illustrated in FIG. 2. While the applications 120 are shown in FIG. 1 to form part of the networked system 102, it will be appreciated that, in alternative embodiments, the applications 120 may form part of a service that is separate and distinct from the networked system 102. With some embodiments, the application servers 118 hosts what is referred to herein as an entity visibility compliance system 200. The entity visibility compliance system 200 is described in more detail below in conjunction with FIG. 2.

Further, while the system 100 shown in FIG. 1 employs a client-server architecture, the present invention is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

Turning now to FIG. 2, an entity visibility compliance system 200 includes a determination module 202, an entity module 204, and a database 206. The modules of the entity visibility compliance system 200 may be implemented on or executed by a single device such as an entity visibility compliance device, or on separate devices interconnected via a network. The aforementioned entity visibility compliance device may be, for example, one of the client machines (e.g. 110, 112) or application server(s) 118 illustrated in FIG. 1. The operation of each of the aforementioned modules of the entity visibility compliance system 200 will now be described in greater detail in conjunction with the various figures.

In some example embodiments, the entity visibility compliance system 200 may access a set of entity visibility compliance rules associated with different regions (e.g., countries, states, nations, administrative regions, sovereignties, jurisdictions, and so on). For example, the entity visibility compliance rules may indicate whether it is acceptable to sell a particular product item or service online, to publish item information (e.g., an item listing) for the particular product item or service, to market the product item or service online, to display the product item or service in online search results, and so on, with respect to various regions. For example, the entity visibility compliance rules for a particular region may indicate that it is acceptable to show a particular product in search results, but not to display anything further pertaining to the product (e.g., preventing the user from selecting the item in the search results). As another example, the entity visibility compliance rules for a particular region may indicate that it is acceptable to display a product in search results and to view item information (e.g., an item listing page) for the product, but the user may not actually purchase the product. As another example, the entity visibility compliance rules for a particular region may indicate that it is acceptable to display the product in search results, to allow users to access the item information (e.g., item listing page) for the product, and to allow users to purchase the product, but it is not acceptable to actively market or promote the product by displaying advertisements, promotions, coupons, deals, etc. associated with the product.

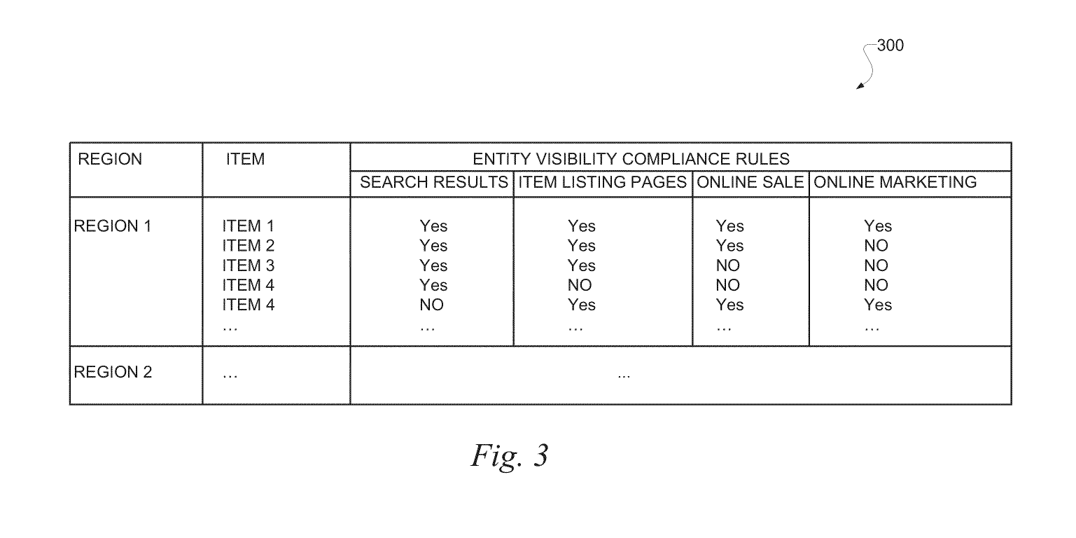

For example, FIG. 3 illustrates an example of entity visibility compliance rules 300 that identify, for each of various regions, various entity visibility compliance rules associated with various items (or item categories, item classes, item title keywords, etc.). For example, the entity visibility compliance rules 300 indicate whether a particular item may appear in search results viewable by users in a given region, or whether the particular item may appear in item information (e.g., item listing pages) accessible by users in a given region, or whether the particular item may be sold to users in a given region, or whether the particular item may be marketed to viewers in a given region, and so on. Although not illustrated in FIG. 3, the entity visibility compliance rules 300 may include other information (e.g., whether items may be shipped to a given region, whether items may be shipped to a given region from certain other regions, whether items may be sold in a particular region from a certain online retailer, marketplace website, or other networked commerce system, and so on). The entity visibility compliance rules 300 may be stored locally at, for example, the database 206 illustrated in FIG. 2, or may be stored remotely at a database, data repository, storage server, etc., that is accessible by the entity visibility compliance system 200 via a network (e.g., the Internet).

The aforementioned entity visibility compliance rules are merely exemplary, and it is understood that the entity visibility compliance rules may include any rules or regulations from a region regarding the importation, sale, display, description, etc. of products and services. For example, the rules for a given region may specify whether a specific product can be shipped into that region, whether a specific product item or service can be shipped to that region from another particular region, whether the product item or service can be shipped to that region if the sale takes place in another particular region, and so on. In some embodiments, the entity visibility compliance rules may apply to the current location of the seller (e.g., a rule stating that a particular product item or service cannot be shipped out of a given region, or cannot be displayed to users in another region, etc.), in some embodiments, the entity visibility rules may not only be grouped by “regions” but also might be specified by types of products/services, sellers, and any other number of dimensions. For example, a seller might allow us to sell products worldwide but not allow us to include the product in collections or in merchandizing for the purpose of controlling a brand experience. This rule might or might not have a geographic dimension.

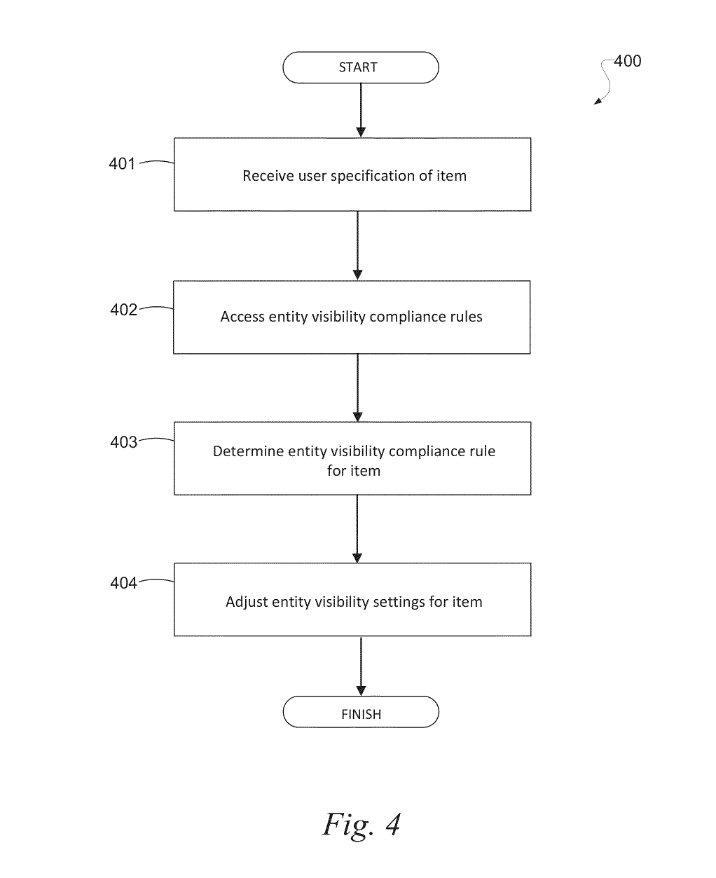

FIG. 4 is a flowchart illustrating an example method 400, consistent with various exemplary embodiments described herein. The method 400 may be performed at least in part by, for example, the entity visibility compliance system 200 illustrated in FIG. 2 (or an apparatus having similar modules, such as client machines 110 and 112 or application server 118 illustrated in FIG. 1). In operation 401, the determination module 202 receives, via a user interface, a user specification of an item or product in connection with a request to post item information (e.g., an item listing) on a networked commerce system (e.g., marketplace website). In operation 402, the determination module 202 accesses entity visibility compliance rules regarding the online sale of items in one or more regions (e.g., see FIG. 3). In operation 403, the determination module 202 determines that the item specified by the seller in operation 401 (or a buyer, an algorithm or third party) is subject to a particular entity visibility compliance rule in a particular region, based on the accessed entity visibility compliance rules. For example, the entity visibility compliance rules may state that the item information (e.g., the item listing) cannot be visible to viewers in the particular region, or the entity visibility compliance rules may state that the item information (e.g., the item listing) cannot appear in search results to viewers in the particular region, or the entity visibility compliance rules may state that the item cannot be sold to buyers in the particular region, and so on. In operation 404, the entity module 204 adjusts entity visibility settings for the item information (e.g., the item listing) in the particular region, based on the particular entity visibility compliance rule identified in operation 403. For example, the entity module 204 may prevent the item information (e.g., the item listing) from being visible to viewers in the particular region, or the entity module 204 may prevent the item information (e.g., the item listing) from appearing in search results to viewers in the particular region, or the entity module 204 may prevent the item from being sold to buyers in the particular region, and so on, based on the entity visibility compliance rules.

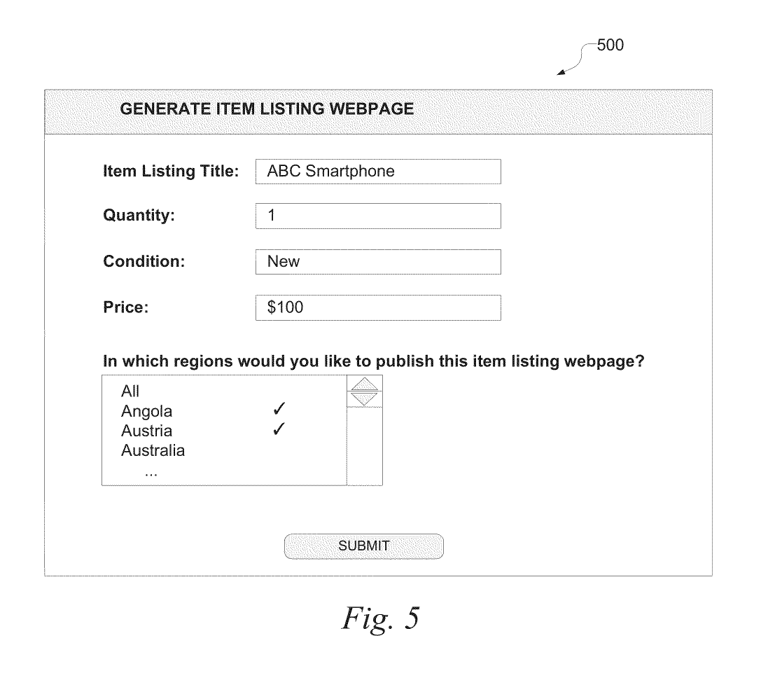

In some embodiments, the entity visibility compliance system 200 may provide guidance, options, or suggestions to a seller regarding whether they may offer their product items or services for sale in various regions. For example, the entity visibility compliance system 200 may receive the specification of a product item or service from a seller, perhaps when the seller is attempting to generate item information (e.g., an item listing page) for sale of the product item or service. In particular, the entity visibility compliance system 200 may display a user interface allowing the seller to specify target regions where the seller desires to offer the product item or service for sale. Based on the sellers specifications of target regions, the entity visibility compliance system 200 may consult the entity visibility compliance rules in order to determine whether the product item or service can be sold in any of those regions. If the product cannot be sold in one or more target regions, the entity visibility compliance system 200 may notify the seller and prevent the seller from publishing that item information (e.g., the item listing) in that target region or offering the product item or service for sale in that target region, in addition, the entity visibility compliance system 200 may suggest to the user other regions (e.g., other than the user-specified target regions) where the product may be offered for sale. In some embodiments, the entity visibility compliance system 200 may prepopulate a list of available regions based on the entity visibility compliance settings. For example, the entity visibility compliance system 200 may display a user interface element (e.g., a pull-down menu) configured to receive a user specification of target regions from among a set of candidates, where the candidates only include the regions where the item information (e.g., the item listing) can be offered for sale, marketed, displayed in search results, etc. (e.g., see the user interface 500 illustrated in FIG. 5).

After the appropriate target regions are identified for given item information (e.g., a given item listing), the item information may be published on the online retailer, marketplace website, or other networked commerce system, where the visibility of the item information (or the visibility of the item information in search results, or the visibility of marketing related to the item listing, etc.) to viewers in various regions is controlled, based on the entity visibility compliance rules.

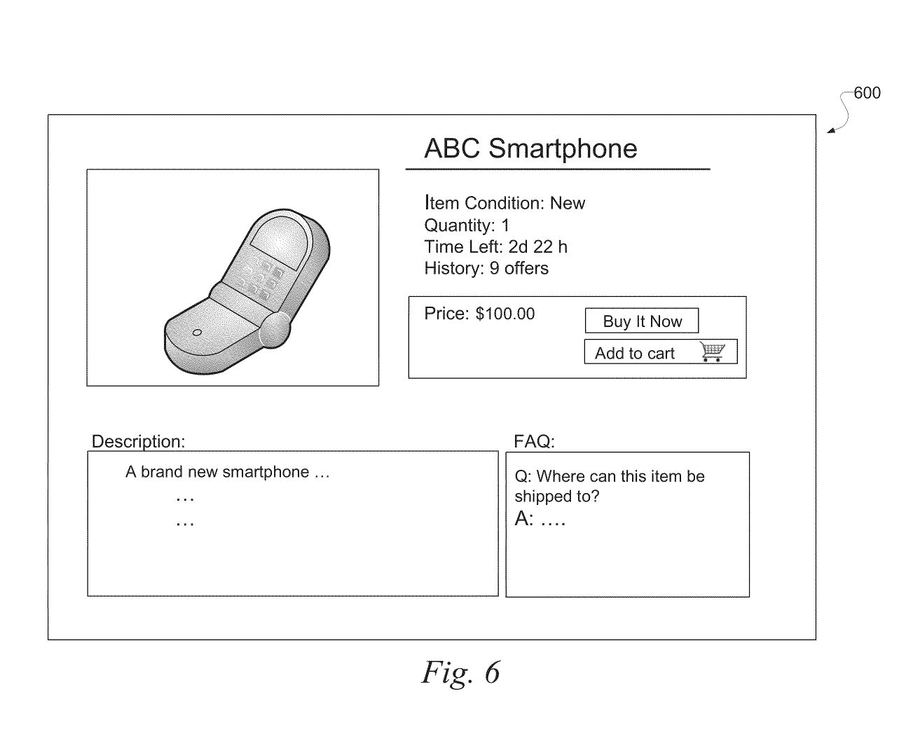

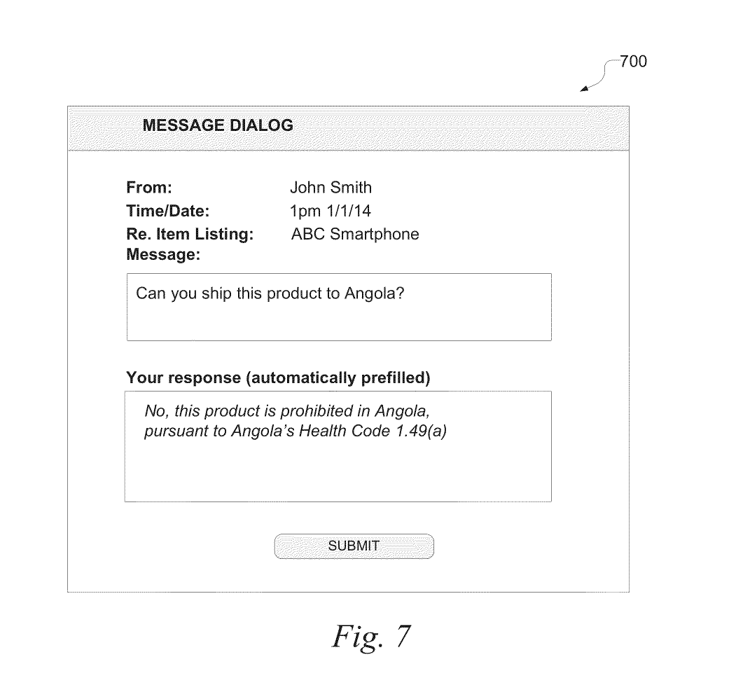

Accordingly, the entity visibility compliance system 200 may access entity visibility compliance rules in order to provide a seller with advice or guidance regarding whether a particular product item or service may be sold in a particular region, or to prevent a seller from listing an item in a particular region, or to control the visibility of the particular item in a particular region. In some embodiments, the entity visibility compliance system 200 may provide a region-specific frequently asked questions (FAQs) or information for a particular item that is automatically posted or referenced in item listings for the particular item and that is customized for the region of the viewer (e.g., see the exemplary item listing webpage 600 in FIG. 6). In some embodiments, the entity visibility compliance system 200 may provide a seller with draft and/or automated responses for responding to user queries (“e.g., can you ship this to me?”) from users in a particular region regarding the particular item (e.g., see user interface 700 in FIG. 7). In some embodiments, the entity visibility compliance system 200 may automatically respond, on behalf of the seller, to user queries regarding a particular item that are received at a networked commerce system (e.g., marketplace website) from users in a particular region. The entity visibility compliance system 200 may determine if a user (e.g., a user viewing an item listing webpage, a user viewing an FAQ, a user sending a message) is located in a given region based on, for example, an Internet protocol (IP) address received from a device utilized by the user to view the networked commerce system (e.g., marketplace website), or geo-location information from a mobile device utilized by a user to view the networked commerce system, and so on. In some embodiments, if a user has logged into the networked commerce system and has a profile with a networked commerce system, then the user's profile may indicate their location, which the entity visibility compliance system 200 may assume is their current location where they are viewing the item listing from.

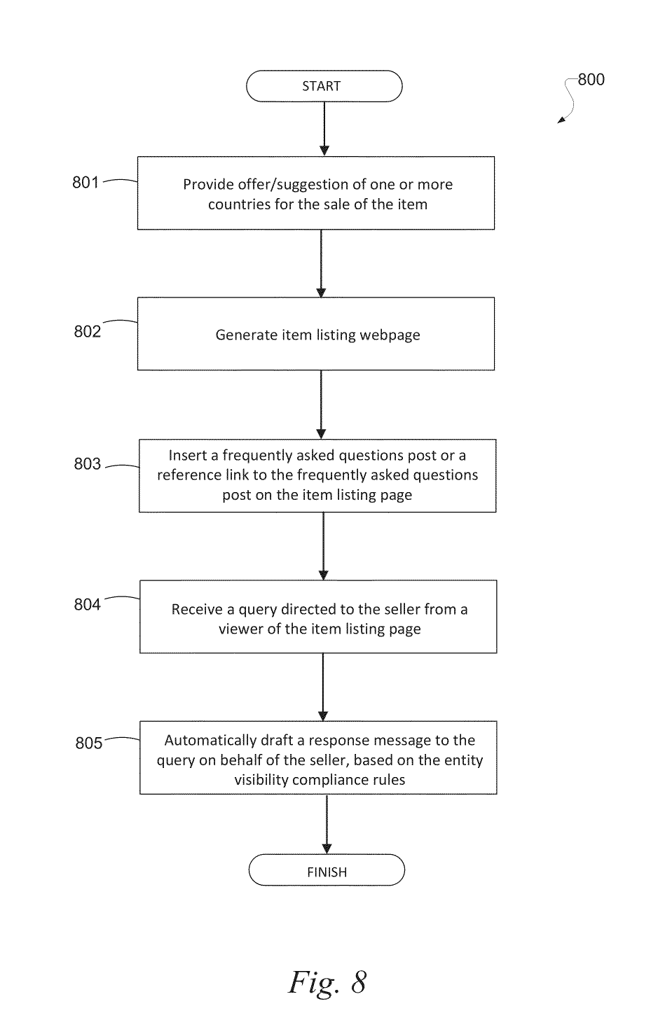

FIG. 8 is a flowchart illustrating an example method 800, consistent with various embodiments described above. The method 800 may be performed at least in part by, for example, the entity visibility compliance system 200 illustrated in FIG. 2 (or an apparatus having similar modules, such as client machines 110 and 112 or application server 118 illustrated in FIG. 1). In operation 801 in FIG. 8, the entity module 204 provides, to the seller, an offer or suggestion of one or more available regions for the sale of the item (e.g., see FIG. 5), based on the entity visibility compliance rules. The entity module 204 may receive a user specification of one or more of the available regions. In operation 802 in FIG. 8, the entity module 204 generates item information, based on the user selection of available regions. In operation 803 in FIG. 8, the entity module 204 inserts a frequently asked questions post or a reference link to the frequently asked questions post on the item information (e.g., item listing webpage, see FIG. 6), based on the entity visibility compliance rules. In operation 804 in FIG. 8, the determination module 202 receives a query directed to the seller (or a customer support agent or any authorized interested user) from a viewer/receiver of the item information (e.g., item listing webpage), the query being related to one of the entity visibility compliance rules. In operation 805 in FIG. 8, the determination module 202 automatically drafts a response message to the query on behalf of the seller (or customer support agent or authorized interested user) (e.g., see FIG. 7), based on the entity visibility compliance rules. Various operations in the method 800 may be omitted or rearranged, as necessary.

In some embodiments, the entity visibility compliance system 200 may utilize the entity visibility compliance rules in order to control what types of listings are visible to users of a networked commerce system in different regions. For example, the entity visibility compliance system 200 may utilize the entity visibility compliance rules in order to generate different versions of networked commerce system (e.g., different websites or item listing webpages) for different regions, such as the US version, an Australian version, a UK version, a Chinese version, etc., where each version of the networked commerce system (e.g., website or item listing webpage) only displays items and item listings in compliance with the entity visibility compliance rules for each region. Each version of the networked commerce system (e.g., each of the websites or item listing webpages) may be associated with distinct identifiers or reference links, such as uniform resource locators (URLs) or uniform resource identifiers (URIs). The entity visibility compliance system 200 may determine if a user is viewing the networked commerce system from a given region based on, for example, an Internet protocol (IP) address received from a device utilized by a user to view the networked commerce system, or geo-location information from a mobile device utilized by a user to view the networked commerce system, and so on. In some embodiments, if a user has logged into the networked commerce system and has a profile with a networked commerce system, then the user's profile may indicate their location, which the entity visibility compliance system 200 may assume is their current location where they are viewing the item listing from. Thus, when users in a given region access a reference link (e.g., URL) associated with the networked commerce system, they may be directed or redirected to the local version of the networked commerce system (e.g., website).

In some cases, item listings that are already displayed on at least one version of a networked commerce system (e.g., US version, Australian version, European version, etc.) may not be displayed on another version of the networked commerce system. For example, perhaps a product item or service is available on a US version of a networked commerce system, but has been removed from the Chinese version of the networked commerce system because it violates Chinese rules regarding what type of content items may be sold in China. However, a user in China may still attempt to access the US version of the networked commerce system (e.g., website) in order to view the content item. Accordingly, if the entity visibility compliance system 200 detects that the user in China is attempting to access the US version of the networked commerce system, the entity visibility compliance system 200 may adjust the visibility of that item so that it does not appear to the user in China. Thus, the entity visibility compliance system 200 can adjust how users in each region are able to view content on the networked commerce system.

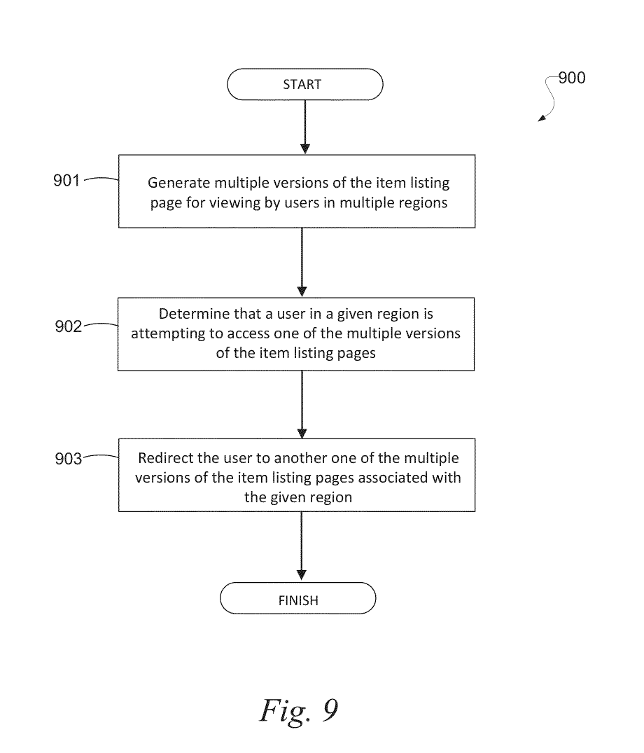

FIG. 9 is a flowchart illustrating an example method 900, consistent with various embodiments described above. The method 900 may be performed at least in part by, for example, the entity visibility compliance system 200 illustrated in FIG. 2 (or an apparatus having similar modules, such as client machines 110 and 112 or application server 118 illustrated in FIG. 1). In operation 901 in FIG. 9, the entity module 204 generates, based on the entity visibility compliance rules, multiple versions of the item information (e.g., item listing pages) for viewing by users in multiple regions, each version of the item information being accessible by different uniform resource locators (URLs) or uniform resource identifiers (URI's). In operation 902 in FIG. 9, the entity module 204 determines that a user in a given region is attempting to access one of the multiple versions of the item information associated with a second region distinct from the given region of the user. In operation 903 in FIG. 9, the entity module 204 redirects the user to another one of the multiple versions of the item information associated with the given region of the user.

In some embodiments, the entity visibility compliance system 200 may access other types of compatibility rules and/or operation standards for items in different regions that may or may not be related to entity visibility compliance rules described herein (e.g., DVD player region compatibility rules, AC voltage compatibility rules, etc.). Examples of compatibility rules and/or operation standards include a DVD region standard, an electrical power outlet frequency or voltage standard, an environmental standard, a local industry (i.e. DIN or ISO) standard, a child protection (i.e. ESRB) standard, an energy efficiency, a safety standard, or any other standard or regulation that differentiates the regions that a buyer and seller operate in or that an item may be shipped from and shipped to. Accordingly, the entity visibility compliance system 200 may access such compatibility rules and/or operational standards in order to provide a seller with advice regarding whether a particular product item or service should be sold in a particular region, or to prevent a seller from listing an item in a particular region, or to control the visibility of the particular item in a particular region, or to provide a seller with the draft and/or automated responses for responding to user queries (“e.g., can you ship this to me?”) from users in a particular region regarding the particular item, or to provide a region-specific FAQ for a particular item that is automatically posted or referenced in item listings for the particular item, or to provide automated responses to user queries regarding a particular item that were received at a networked commerce system from users in a particular region, and so on, based on whether the product item or service is compatible with various systems (e.g., DVD systems, electrical systems, etc.) in that region.

In some embodiments, the content of the entity visibility compliance rules may be specified based on user input. For example, the entity visibility compliance system 200 may display a user interface allowing a user to specify entity visibility compliance rules for various products and services in various regions. The aforementioned user may correspond to, for example, an employee of the company (e.g., an executive or a member of the legal team of a networked commerce system such as eBay), a buyer or seller on a networked commerce system, and so on.

In some embodiments, the entity visibility compliance rules may be generated based on user input or other information from government officials of different regions. For example, if the entity visibility compliance system 200 detects a request from a government official of region X to a seller (or to a networked commerce system) to stop offering a product P for sale in region X, the entity visibility compliance system 200 may infer with high probability that the sale of product P in region X is unlawful. Accordingly, the entity visibility compliance system 200 may generate or adjust the entity visibility compliance rules accordingly. As another example, the entity visibility compliance system 200 may transmit questionnaires or surveys to government officials in different regions, and generate or adjust the entity visibility compliance rules based on the responses received from the government officials.

In some embodiments, the entity visibility compliance rules may be generated by accessing or crawling information from external and/or third-party data sources. For example, the entity visibility compliance system 200 may include a crawling engine or crawling module (not shown in FIG. 2) configured to crawl webpages describing entity visibility compliance rules, where the webpages may be associated with different individuals or organizations that may have experience or relevant information pertaining to the sale and shipment of goods to different regions. For example, the entity visibility compliance system 200 may crawl webpages of a company situated or doing business in a particular region, where the webpages describe rules regarding what kind of products and services can be sold, marketed, or shipped to that region. As another example, the entity visibility compliance system 200 may crawl webpages associated with government organizations (e.g., customs services, clearance services, immigration services, border patrol services, Coast Guard services, non-profit organizations, military organizations, a region related regulatory government or non-government agency, etc.) describing rules regarding what kind of products and services can be sold, marketed, or shipped to that region. As another example, the entity visibility compliance system 200 may crawl webpages that describe the legal requirements or laws in a particular region (e.g., webpages of government organizations in various regions, webpages of lawyers and law firms in various regions, webpages associated with media companies and newspapers, articles, publications, etc.). As another example of, the entity visibility compliance system 200 may crawl webpages associated with mailing services and courier services doing business in various regions (e.g., services such as FedEx, UPS, DHL, shipping brokers, etc.), where the webpages describe rules regarding what kind of products and services can be sold or shipped to that region. Accordingly, based on such crawled information, the entity visibility compliance system 200 may generate or adjust the entity visibility compliance rules accordingly.

In some cases, the entity visibility compliance rules may actually specify that specific words, phrases, images, depictions, text in a particular language, etc., may not be displayed in a given region (e.g., in connection with an online item listing), notwithstanding the fact that the underlying item associated with such an item listing is actually permitted to be sold online in that region. For example, perhaps a rule states that all item listings in a given region must be in a particular language and cannot include any depictions of trees. Accordingly, the entity visibility compliance system 200 may restrict the visibility of such item listings from certain viewers, based on such entity visibility compliance rules. Alternatively, the entity visibility compliance system 200 may restrict the visibility of specific portions of the item listings from certain viewers, based on such entity visibility compliance rules. For example, if reviews of a product or seller are included in a webpage associated with an item listing, then the entity visibility compliance system 200 may restrict the display of a particular review from users in a given region if it violates one or more entity visibility compliance rules associated with that region. Accordingly, the entity visibility compliance system 200 may provide a seller with advice or warnings regarding content in their item listing, and perhaps provide suggestions for alternative content or provide the seller with access to alternative content (e.g., reference links for accessing boilerplate or stock descriptions and photos).

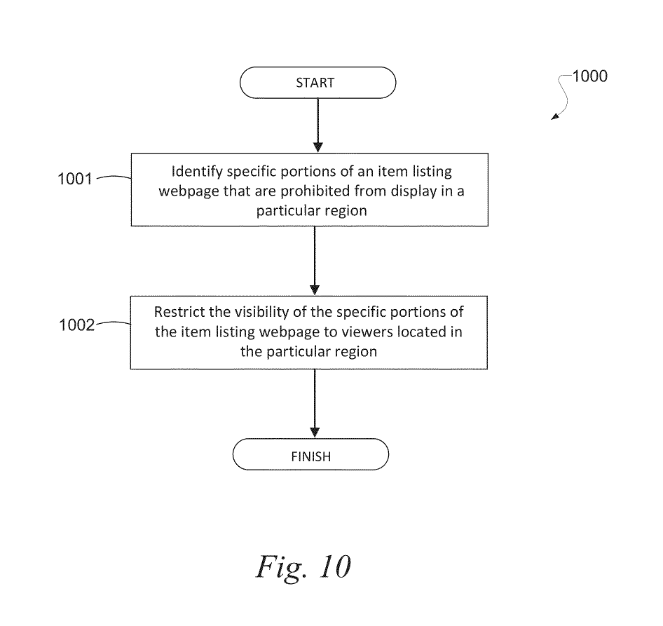

FIG. 10 is a flowchart illustrating an example method 1000, consistent with various embodiments described above. The method 1000 may be performed at least in part by, for example, the entity visibility compliance system 200 illustrated in FIG. 2 (or an apparatus having similar modules, such as client machines 110 and 112 or application server 118 illustrated in FIG. 1). In operation 1001 in FIG. 10, the determination module 202 identifies specific portions of item information (e.g., an item listing webpage) that are prohibited from display in a particular region, based on content rules included in the entity visibility compliance rules. For example, the content rules may specify that a particular word, icon, symbol, or image is prohibited from display in the particular region. In operation 1002 in FIG. 10, the entity module 204 restricts the visibility of the specific portions of the item information (e.g., item listing webpage) to viewers located in the particular region.

In some embodiments, the entity visibility compliance system 200 may generate the entity visibility compliance rules based on statistical machine learning techniques, such as based on a machine learning algorithm (unassisted or assisted by humans) from public or private data. For example, the entity visibility compliance system 200 may access and analyze log/transaction data associated with a networked commerce system, where the data describes various item listings, transactions, and sales pending or occurring in different regions. In some embodiments, the entity visibility compliance system 200 may determine that, for example, a statistically significant portion of sales of a particular product in a particular region are executed or completed successfully, and thus the entity visibility compliance system 200 may infer that the sale of that particular product in that region is likely to be lawful. On the other hand, the entity visibility compliance system 200 may determine that, for example, a statistically significant portion of sales of a particular product in a particular region are not executed or completed successfully because of complaints of government officials, and thus the entity compliance system 200 may infer that the sale the particular product in that region may be unlawful, restricted, or problematic in some way. In some embodiments, the entity visibility compliance system 200 may then notify a user (e.g., member of a legal team of the networked commerce system) of these various determinations, and request human review of the determinations as to whether the various product items or services may or may not be sold in various regions.

### Example Mobile Device

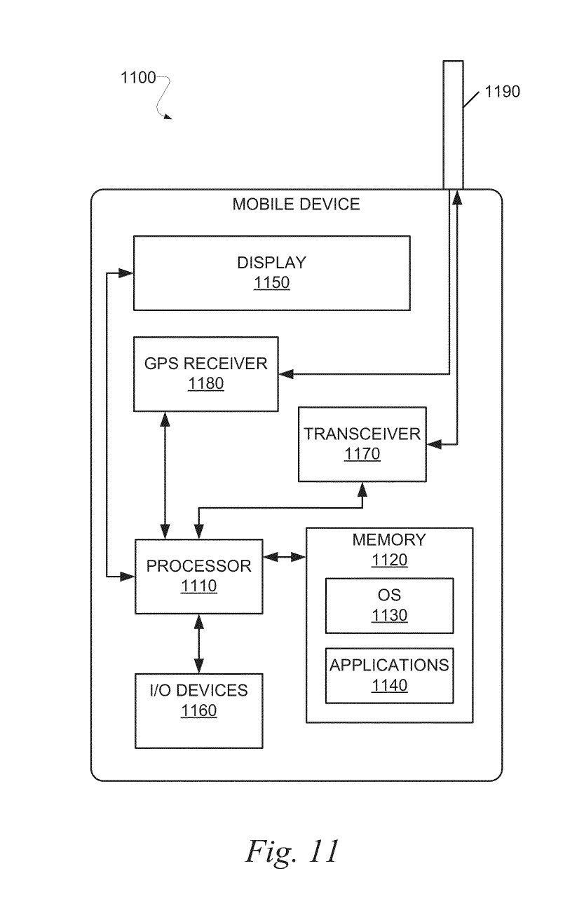

FIG. 11 is a block diagram illustrating the mobile device 1100, according to an example embodiment. The mobile device may correspond to, for example, client machines 110 and 112 or application server 118 illustrated in FIG. 1. One or more of the modules of the system 200 illustrated in FIG. 2 may be implemented on or executed by the mobile device 1100. The mobile device 1100 may include a processor 1110. The processor 1110 may be any of a variety of different types of commercially available processors suitable for mobile devices (for example, an XScale architecture microprocessor, a Microprocessor without interlocked Pipeline Stages (MIPS) architecture processor, or another type of processor). A memory 1120, such as a Random Access Memory (RAM), a Flash memory, or other type of memory, is typically accessible to the processor 1110. The memory 1120 may be adapted to store an operating system (OS) 1130, as well as application programs 1140, such as a mobile location enabled application that may provide location based services to a user. The processor 1110 may be coupled, either directly or via appropriate intermediary hardware, to a display 1150 and to one or more input/output (I/O) devices 1160, such as a keypad, a touch panel sensor, a microphone, and the like. Similarly, in some embodiments, the processor 1110 may be coupled to a transceiver 1170 that interfaces with an antenna 1190. The transceiver 1170 may be configured to both transmit and receive cellular network signals, wireless data signals, or other types of signals via the antenna 1190, depending on the nature of the mobile device 1100. Further, in some configurations, a GPS receiver 1180 may also make use of the antenna 1190 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations, it will be appreciated that the decision to implement a hardware-implemented module mechanically, in dedicated and permanently configured circuitry, or in temporarily configured circuitry e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

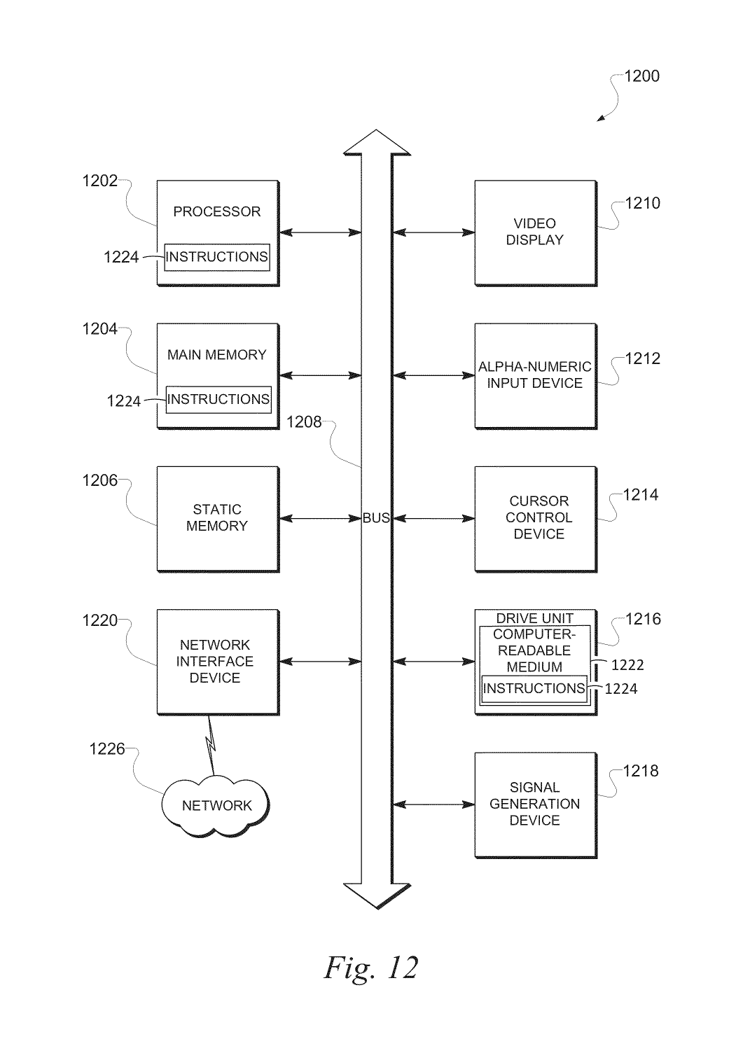

FIG. 12 is a block diagram of machine in the example form of a computer system 1200 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard or a touch-sensitive display screen), a user interface (UI) navigation device 1214 (e.g., a mouse), a disk drive unit 1216, a signal generation device 1218 (e.g., a speaker) and a network interface device 1220.

### Machine-Readable Medium

The disk drive unit 1216 includes a machine-readable medium 1222 on which is stored one or more sets of instructions and data structures (e.g., software) 1224 embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
receiving, via an interface, a seller specification of an item in connection with a request to post item information offering the item for sale on a networked commerce system;
accessing entity visibility compliance rules regarding the online sale of items in one or more regions;
determining, using one or more processors, that the item specified by the seller is subject to a particular entity visibility compliance rule in a particular region; and
adjusting an entity visibility setting for the item information throughout the networked commerce system in the particular region, based on the particular entity visibility compliance rule.

2. The method of claim 1, wherein the particular entity visibility compliance rule specifies at least one of:
whether the item may be sold to buyers located in the particular region;
whether the item may be shipped to the particular region;
whether the item information may be displayed to users located in the particular region;
whether the item may be displayed in search results to users located in the particular region;
whether the item may be actively marketed to users in the particular region;
whether the item may be shipped from a region associated with the current location of the seller; and
whether the item information might be used in processing by the networked commerce system in order to determine eligibility for displaying or passing on the item information to other users connected to the networked commerce system based on their belonging to a certain region.

3. The method of claim 1, further comprising:
providing, to the seller, a suggestion or restriction of one or more regions for the sale of the item, based on the entity visibility compliance rules.

4. The method of claim 1, further comprising inserting a frequently asked questions post or a reference link to the frequently asked questions post on the item information, based on the entity visibility compliance rules.

5. The method of claim 1, further comprising:
receiving a query directed to the seller, a customer support agent or an authorized interested user from a viewer or receiver of the item information, the query being related to one of the entity visibility compliance rules; and
automatically drafting a response message to the query, based on the entity visibility compliance rules.

6. The method of claim 1, further comprising:
generating, based on the entity visibility compliance rules, multiple versions of the item information for viewing by users in multiple regions, each version of the item information being accessible by different identifiers.

7. The method of claim 6, further comprising:
determining that a user in a given region is attempting to access one of the multiple versions of the item information associated with a second region distinct from the given region; and
redirecting the user to another one of the multiple versions of the item information associated with the given region.

8. The method of claim 1, wherein the entity visibility compliance rules further specify whether the item is compliant with an operational standard in the particular region.

9. The method of claim 8, wherein the operational standard is at least one of a DVD region standard, an electrical power outlet frequency standard, an electrical power outlet voltage standard, an environmental standard, a local industry standard, a child protection standard, an energy efficiency standard, and a safety standard.

10. The method of claim 1, wherein the entity visibility compliance rules are generated based on user input.

11. The method of claim 1, herein the entity visibility compliance rules are generated by at least one of:
crawling one or more online sources of compliance rules; and
a machine learning algorithm from public or private data.

12. The method of claim 11, wherein the one or more online sources include at least one of a source of information associated with a courier delivery service, a region related regulatory government or non-government agency, and a national customs agency.

13. The method of claim 1, wherein the entity visibility compliance rules specify that a particular word, icon, symbol, or image is prohibited from display in the particular region.

14. The method of claim 13, further comprising:
identifying specific portions of the item information that are prohibited from display in the particular region, based on the entity visibility compliance rules; and
restricting the visibility of the specific portions of the item information from viewers located in the particular region.

15. A system comprising:
a machine including a memory and at least one processor;
a determination module, executable by the machine, configured to:
receive, via an interface, a seller specification of an item in connection with a request to post item information offering the item for sale on a networked commerce system;
access entity visibility compliance rules regarding the online sale of items in one or more regions; and
determine that the item specified by the seller is subject to a particular entity visibility compliance rule in a particular region; and
an entity module configured to adjust an entity visibility setting for the item information throughout the networked commerce system in the particular region, based on the particular entity visibility compliance rule.

16. The system of claim 15, wherein the entity module is further configured to:
provide, to the seller, a suggestion or restriction of one or more regions for the sale of the item, based on the entity visibility compliance rules.

17. The system of claim 15, further comprising a crawling module configured to generate the entity visibility compliance rules by crawling one or more online sources of compliance rules.

18. A non-transitory machine-readable storage medium comprising instructions that, when executed by one or more processors of a machine, cause the machine to perform operations comprising:
receiving, via an interface, a seller specification of an item in connection with a request to post item information offering the item for sale on a networked commerce system;
accessing entity visibility compliance rules regarding the online sale of items in one or more regions;
determining that the item specified by the seller is subject to a particular entity visibility compliance rule in a particular region; and
adjusting an entity visibility setting for the item information throughout the networked commerce system in the particular region, based on the particular entity visibility compliance rule.

19. The storage medium of claim 18, wherein the operations further comprise:
providing, to the seller, a suggestion or restriction of one or more regions for the sale of the item, based on the entity visibility compliance rules.

20. The storage medium of claim 18, wherein the operations further comprise:
crawling one or more online sources of compliance rules to generate the entity visibility compliance rules.
